(19) United States
(12) Patent Application Publication
(10) Pub. No.: US 2024/0160904 A1
(43) Pub. Date: May 16, 2024

(54) GRAPH LEARNING ATTENTION MECHANISM

(71) Applicant: International Business Machines Corporation, Armonk, NY (US)

(72) Inventors: YADA ZHU, Irvington, NY (US); Mattson Thieme, Evanston, IL (US); ONKAR BHARDWAJ, Lexington, MA (US); David Cox, Somerville, MA (US)

(21) Appl. No.: 17/979,817

(22) Filed: Nov. 3, 2022

(51) Int. Cl. G06N 3/04; B60W 60/00; G06N 5/04; G06Q 20/40

(52) U.S. Cl. CPC G06N 3/0481; B60W 60/00276; G06N 5/04; G06Q 20/4016

(57) ABSTRACT

A graph with a plurality of nodes, a plurality of edges, and a plurality of node features is obtained and node representations for the node features are generated. A plurality of structure learning scores is generated based on the node representations, each structure learning score corresponding to one of the plurality of edges. A subset of the plurality of edges that identify a subgraph is selected, each edge of the subset having a structure learning score that is greater than a given threshold. The subgraph is inputted to a representation learner and an inferencing operation is performed using the representation learner based on the subgraph.

### BACKGROUND

The present invention relates generally to the electrical, electronic and computer arts and, more particularly, to machine learning.

Graph Neural Networks (GNNs) are local aggregators that are highly sensitive to network structure and derive their expressive power from their sensitivity to network structure. However, this sensitivity comes at a cost: (i) noisy edges degrade performance and (ii) most graphs are constructed using heuristics and, as such, contain noisy edges. In response, many GNNs include edge-weighting mechanisms that scale the contribution of each edge in the aggregation step. However, to account for neighborhoods of varying size, node-embedding mechanisms must typically normalize these edge-weights across each neighborhood. As such, the impact of noisy edges cannot be eliminated without removing those edges altogether.

### BRIEF SUMMARY

Principles of the invention provide a graph learning attention mechanism. In one aspect, an exemplary method includes the operations of obtaining a graph with a plurality of nodes, a plurality of edges, and a plurality of node features, generating node representations for the node features, generating a plurality of structure learning scores based on the node representations, each structure learning score corresponding to one of the plurality of edges, selecting a subset of the plurality of edges that identify a subgraph, each edge of the subset having a structure learning score that is greater than a given threshold, inputting the subgraph to a representation learner, and performing an inferencing operation using the representation learner based on the subgraph.

In one aspect, an exemplary non-transitory computer readable medium comprises computer executable instructions which when executed by a computer cause the computer to perform the method of obtaining a graph with a plurality of nodes, a plurality of edges, and a plurality of node features, generating node representations for the node features, generating a plurality of structure learning scores based on the node representations, each structure learning score corresponding to one of the plurality of edges, selecting a subset of the plurality of edges that identify a subgraph, each edge of the subset having a structure learning score that is greater than a given threshold, inputting the subgraph to a representation learner, and performing an inferencing operation using the representation learner based on the subgraph.

In one aspect, an exemplary apparatus comprises a memory and at least one processor, coupled to the memory, and operative to perform operations comprising obtaining a graph with a plurality of nodes, a plurality of edges, and a plurality of node features, generating node representations for the node features, generating a plurality of structure learning scores based on the node representations, each structure learning score corresponding to one of the plurality of edges, selecting a subset of the plurality of edges that identify a subgraph, each edge of the subset having a structure learning score that is greater than a given threshold, inputting the subgraph to a representation learner, and performing an inferencing operation using the representation learner based on the subgraph.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:

improves the technological process of performing machine learning on something amenable to representation by a graph, using a representation learner such as a GNN or the like, by pre-processing the graph using exemplary techniques disclosed herein. Prior art techniques employ heuristics and have noisy edges, to which GNNs are sensitive; thus, prior art techniques suffer from problems in learning edge weights in the presence of noisy edges. Pre-processing according to one or more embodiments removes the problematic edges, advantageously overcoming the conflicting demands of structure learning versus node embedding inherent in prior-art approaches. One or more embodiments separate structure learning and node embedding tasks; the graph produced from the GLAM layer in one or more embodiments is optimized for the downstream task—there is no need to know a priori what the optimal graph is. In one or more embodiments, the graph structure is informed by the task (classification, regression) and has better inference performance.

a principled framework for considering the independent tasks and inherent conflicts between structure learning and node embedding;

the disclosed framework is scalable and generalizable to the inductive setting;

a drop-in, differentiable structure learning layer for GNNs that separates the distinct tasks of structure learning and node embedding;

the structure learning layer induces an order of magnitude greater sparsity than conventional structure learning methods;

the structure learning layer is end-to-end differentiable and can be utilized with arbitrary downstream GNNs;

enables a downstream GNN to be a node embedder and aggregator, and offloads the structure learning task to the differentiable structure learning layer;

a technique for generating graphs that are optimized for downstream task performance;

improves the accuracy of classification, regression, and the like for downstream tasks (of the differentiable structure learning layer);

a generation process that is “context-free” in that the edges are not normalized with respect to other edges in the neighborhood to avoid leaking information from one edge to another;

no requirement for any exogenous regularizers, such as penalties on retained edges, nor edge-selection heuristics, such as top-k selection;

a novel, context-free attention mechanism that enables the network to learn the utility of integrating feature information from neighbors in the presence of randomly evolving neighborhoods;

enables the learning of a task-informed graph structure without the need to augment existing, domain-specific loss functions;

enables the learning of graph structures for any task by using sparse activation functions in the downstream GNN; and

application areas include time series forecasting, computer vision, natural language processing (NLP), scientific discovery, recommendation systems, finance fraud detection systems, and the like, where problems can be formulated with graphs and GNN can be applied.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A illustrates the effects of manually zeroing noisy edges vs. removing the noisy edges;

FIG. 1B is an example dataflow diagram for a Graph Learning Attention Mechanism (GLAM) layer, in accordance with an example embodiment;

FIG. 1C is a high-level overview of how the GLAM layer is used to learn optimal graph structures at each layer, in accordance with an example embodiment;

FIG. 2 is a flowchart for an example method for implementing the GLAM layer, in accordance with an example embodiment;

FIG. 3A is a table of evaluated homophilic graphs (datasets), in accordance with an example embodiment;

FIG. 3B illustrates a table of semi-supervised node classification accuracies (top; listed in percent) and the percentage of edges removed at the first/second layer (bottom), in accordance with an example embodiment; and

FIG. 4 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Principles of the invention provide a graph learning attention mechanism (in a non-limiting example, for learnable sparsification without heuristics). Generally, one or more exemplary embodiments of a drop-in, differentiable structure learning layer for GNNs (referred to as the Graph Learning Attention Mechanism (GLAM) herein), which separate the distinct tasks of structure learning and node embedding, are disclosed. In contrast to existing graph learning approaches, GLAM does not require the addition of exogenous structural regularizers or edge-selection heuristics to learn optimal graph structures.

Local interactions govern the properties of nearly all complex systems, from protein folding and cellular proliferation to group dynamics and financial markets. When modeling such systems, representing interactions explicitly in the form of a graph can improve model performance dramatically, both at the local and global level. Graph Neural Networks (GNNs) are designed to operate on such graph-structured data and have quickly become state of the art in a host of structured domains. However, GNN models rely heavily on the provided graph structures actually representing meaningful underlying relations, such as, for example, the bonds between atoms in a molecule. Additionally, to generate useful node embeddings, GNNs employ permutation invariant neighborhood aggregation functions which implicitly assume that neighborhoods satisfy certain homogeneity properties. If noisy edges are introduced, or if the neighborhood assumptions are not met, GNN performance suffers.

To address both issues simultaneously, many GNNs include mechanisms for learning edge weights which scale the influence of the features on neighboring nodes in the aggregation step. One conventional GNN, for example, adapts the typical attention mechanism to the graph setting, learning attention coefficients between adjacent nodes in the graph as opposed to tokens in a sequence. As described in the section entitled “Conflicting Demands: Node Embedding vs. Structure Learning,” the demands of edge weighting (or structure learning) inherently conflict with those of node embedding, and edge weighting mechanisms that are joined together with node embedding mechanisms are not capable of eliminating the negative impact of noisy edges on their own.

In one example embodiment, a method for separating the distinct tasks of structure learning and node embedding in representation learners, such as GNNs, is disclosed. The exemplary method takes the form of a structure learning layer that can be placed in front of existing GNN layers to learn task-informed graph structures that optimize performance on the downstream task. A principled framework for considering the inherent conflicts between structure learning and node embedding is introduced.

In addition to enabling GAT models to meet or exceed state of the art performance in semi-supervised node classification tasks, the GLAM layer induces an order of magnitude greater sparsity than conventional structure learning methods. Also, in contrast to the existing structure learning methods, GLAM does not employ any edge selection heuristics or exogenous structural regularizers, or otherwise modify the existing loss function to accommodate the structure learning task. This makes GLAM simpler to apply in existing GNN pipelines as there is no need to modify carefully crafted and domain-specific objective functions. The disclosed approach is also scalable and generalizable to the inductive setting as it does not rely on optimizing a fixed adjacency matrix.

### Preliminaries

Graph attention networks (GATs) learn weighted attention scores eᵢⱼ for all edges between nodes i and j, j∈ [symbol] ᵢ, where [symbol] ᵢ is the one-hop neighborhood of node i. These attention scores represent the importance of the features on node j to node i and are computed in the following manner:

eᵢⱼ=LeakyReLU(\vec{a}^{T}[W\vec{h}ᵢ∥W\vec{h}ⱼ] (1)

where \vec{h}ᵢ∈ [symbol] ^{F} are node feature vectors, ∥ is vector concatenation, W∈ [symbol] ^{F′×F} is a shared linear transformation for transforming input features into higher level representations, and \vec{a}∈ [symbol] ^{2F′} are the learnable attention weights that take the form of a single-layer feedforward neural network.

To ensure the attention scores are comparable across neighborhoods of varying size, they are normalized into attention coefficients a αᵢⱼ using a softmax activation:

$${α}_{ij} = {softmax}_{j} ( {e}_{ij} ) = \frac{exp ( {e}_{ij} )}{{\sum }_{j ∈ {𝒩}_{i}} exp ( {e}_{ij} )} \qquad ( 2 )$$

For stability and expressivity, the mechanism is extended to employ multi-head attention, and the outputs of the K heads in the final layer are aggregated by averaging:

$${\vec{h}}_{i}^{′} = softmax ( \frac{1}{K} {\sum }_{k = 1}^{K} {\sum }_{j ∈ {𝒩}_{i}} {α}_{ij}^{k} {W}^{k} {\vec{h}}_{j} ) \qquad ( 3 )$$

It is explained below why the normalization procedure in Eq. (2), while pertinent for node embedding, is an impediment for structure learning.

Conflicting Demands: Node Embedding vs. Structure Learning

At first glance, it may seem that the structure learning problem could be addressed by simply thresholding the existing GAT attention coefficients αᵢⱼ. However, due to the need for neighborhood-wise normalization and permutation invariant aggregation, this would not be ideal. First, it is appropriate to understand why the attention coefficients are calculated as the softmax of the attention scores. This softmax step serves two pertinent purposes:

It normalizes the attention scores into attention coefficients that sum to one, which ensures the sum of the neighboring representations (as defined in Eq. (3)) is also normalized. This is a significant function of any node embedding mechanism because it normalizes the distributional characteristics of \vec{h}ᵢ′ not just across different neighborhoods but across neighborhoods of varying size. Without this, the downstream layers that ingest \vec{h}ᵢ′ would need to account for widely variable magnitudes in the values of \vec{h}ᵢ′, and performance would suffer.

The softmax serves as an implicit, low-resolution structure learning device. To locate the maximum input element in a differentiable manner, softmax uses exponentials to exaggerate the difference between the maximum element and (all of) the rest. In graph attention networks, this means exaggerating the difference between the attention coefficient of the single most important neighbor vs. (all of) the rest. This imbues the attention coefficients, and thus each node's neighborhood, with a soft-sparsity that improves the learned node embeddings by minimizing the influence of all but the single most useful neighbor.

For these reasons, if the aim is to generate useful node embeddings for node-wise prediction, the softmax activation should not be done away with to normalize attention coefficients in each neighborhood. However, since one aim of one or more embodiments is to jointly learn useful node embeddings and the graph structure, this embedding mechanism alone is not sufficient. A distinct structure learning mechanism should thus include the following:

To learn the graph structure, the value of each neighbor should be assessed independently. This is because, in graph learning, local neighborhoods are subject to noisy evolution as the network samples edges. If the value of each neighbor is conditional on the present neighborhood, it will be difficult to disentangle the relative value of one neighbor from another as the neighborhood evolves.

This is why the existing edge-weighting+node embedding paradigm is insufficient, if the goal is to simultaneously learn node embedding and graph structure: the neighborhood-wise normalization (softmax over edge-weights) expresses each neighbors' importance relative to all the other nodes in the neighborhood, which is in direct conflict with the edge-wise independence requirements of structure learning.

To preserve the embedding advantages of GNNs while accommodating the conflicting demands of structure learning, aspects of the Graph Learning Attention Mechanism (GLAM) are introduced.

### The Graph Learning Attention Mechanism (GLAM)

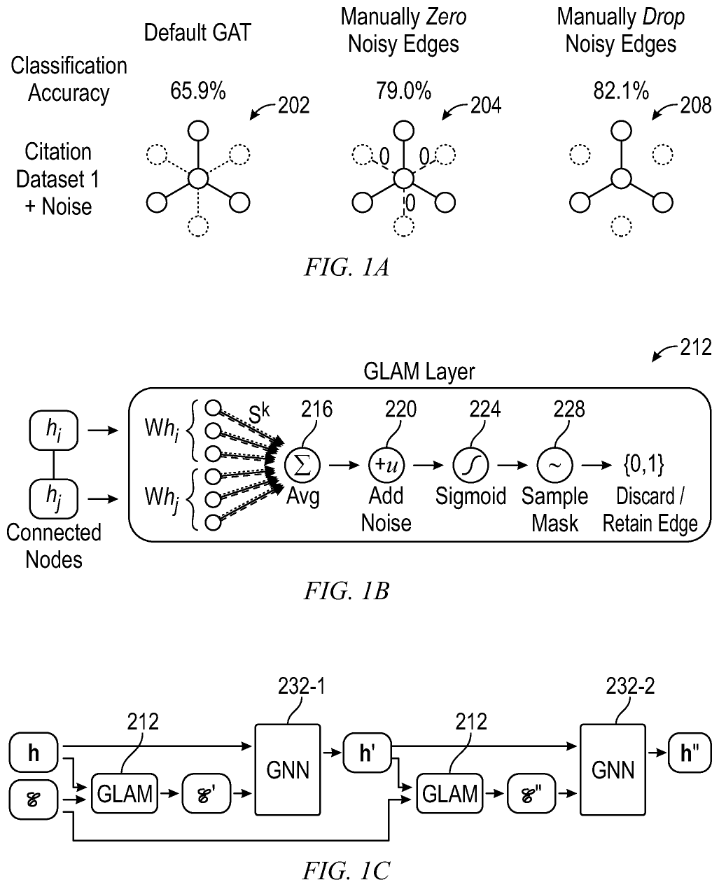

FIG. 1A illustrates the effects of manually zeroing noisy edges vs. removing the noisy edges. An original graph 202 includes seven nodes. The noisy edges may be set to zero, as illustrated in graph 204, with a semi-supervised classification accuracy on a first known citation dataset of 79.0%. If the noisy edges are removed, as illustrated in graph 208, the semi-supervised classification accuracy on the first known citation dataset increases to 82.1%.

FIG. 1B is an example dataflow diagram for a Graph Learning Attention Mechanism (GLAM) layer 212, in accordance with an example embodiment. The GLAM layer 212 is operating on a single pair of connected nodes with features hᵢ, hⱼ∈ [symbol] ^{F}, using the shared weight matrix W∈ [symbol] ^{F}^{_{S}}^{×F} and multi-headed attention with K=3 heads, and generates a probability for discarding or retaining the given edge. Like the GAT layer, the GLAM layer 212 ingests the node features h∈ [symbol] ^{N×F} and the edge set ε, where N is the number of nodes and F is the number of features per node. For each node i, the node features hᵢ are transformed into higher order representations xᵢ using a shared linear transformation W∈ [symbol] ^{F}^{_{S}}^{×F}:

xᵢ=W(\vec{h}ᵢ), xᵢ∈ [symbol] ^{F}^{_{S}} (4)

For each edge between nodes i and j in the provided edge set ε, a representation for that edge is constructed by concatenating the node representations xᵢ and xⱼ. From here, the disclosed GLAM layer 212 differs from the GAT layer. Using another shared linear layer S∈ [symbol] ^{1×F}^{_{S}}, these edge representations are mapped onto structure learning scores η∈ [symbol] ^{|ε|×1}, where the score ηᵢⱼ for each edge becomes:

ηᵢⱼ=σ(S[xᵢ∥xⱼ]+u) (5)

where ∥ is vector concatenation, u∈ [symbol] ¹ is independent and identically distributed (i.i.d.) noise drawn from a U(−0.5, 0.5) distribution centered about zero, and a is a sigmoid activation allowing each ηᵢⱼ to be interpreted as the probability of retaining the edge between nodes i and j.

Finally, the GLAM layer 212 is optionally extended to include K attention heads, and the final structure learning score ηᵢⱼ for each edge becomes (operations 216-224; namely, averaging at 216, adding noise at 220, and applying the sigmoid function at 224):

$${η}_{ij} = σ ( \frac{1}{K} {\sum }_{k = 1}^{K} {S}^{k} [ {x}_{i} ‖ {x}_{j} ] + u ) \qquad ( 6 )$$

Next, a discrete mask M∈{0, 1}^{|ε|} is sampled from the distribution parameterized by the structure learning scores 77 (operation 228). When applied to the given graph ε, a sparsified graph M(ε)→ε′⊆ε is obtained. To differentiably sample the discrete values in M from the continuous probabilities in η, the Gumbel-Softmax reparameterization technique is used and the edge between nodes i and j is retained if ηᵢⱼ is greater than a threshold, such as 0.5.

This new graph E′ is then used in place of ε in the downstream representation learner, such as a GNN. If that downstream GNN were a GAT, using the equations from the section entitled Preliminaries, the attention coefficients would become:

$${α}_{ij} = {softmax}_{j} ( {e}_{ij} ) = \frac{exp ( {e}_{ij} )}{{\sum }_{j ∈ {𝒩}_{i}^{′}} exp ( {e}_{ij} )} \qquad ( 7 )$$

$$and$$

$${\vec{h}}_{i}^{′} = softmax ( \frac{1}{K} {\sum }_{k = 1}^{K} {\sum }_{j ∈ {𝒩}_{i}^{′}} {α}_{ij}^{k} {W}^{k} {\vec{h}}_{j} )$$

where the neighborhoods [symbol] are defined by the non-masked edges in ε′ where η is, for example, greater than 0.5.

As each GNN model incorporates graph structure in its own way, it has been ensured that GLAM layer 212 produces a maximally general, differentiable mask on the given edges. This mask may be readily used to separate the structure learning tasks from node embedding regardless of the particular embedding mechanism.

For example, in the disclosed implementation, the learned graph M is incorporated into the GAT by trivially swapping the softmax over the attention coefficients with a sparse softmax that respects the masked edges (as shown in Eq. (7)). Extending beyond the GAT, the learned graph could be incorporated into the widely used Graph Convolutional Network (GCN), for example, by simply multiplying the adjacency matrix A by the mask M before the application of the renormalization trick. To apply M in arbitrary GNNs, it is only needed to insert it before the neighborhood aggregation step.

FIG. 1C is a high-level overview of how the GLAM layer 212 is used to learn optimal graph structures at each layer, in accordance with an example embodiment. The input is the original graph with node features h∈ [symbol] ^{N×F} and edge set ε. To make as few assumptions about the optimal graph structure as possible, the original edge set ε is fed into each GLAM layer 212 to reassess the utility of each edge at each layer. It is noted that this is optional, and chaining edge sets across layers is also possible. The new graphs ε′ and ε″ are input to the downstream GNNs 232-1, 232-2, respectively.

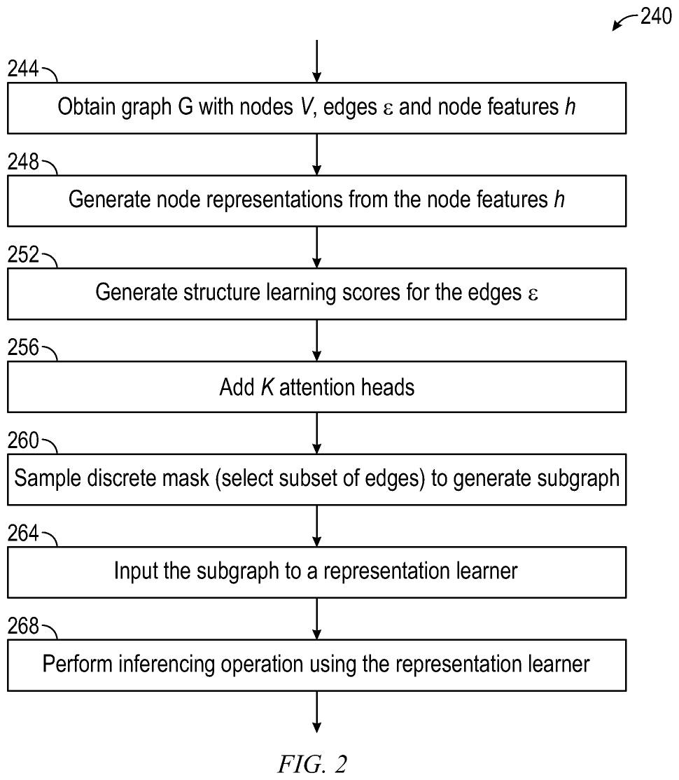

FIG. 2 is a flowchart for an example method 240 for implementing the GLAM layer 212, in accordance with an example embodiment. In one example embodiment, a graph G (h∈V, ε) is input with nodes V, edges ε, and node features h (operation 244). As noted above, like the GAT layer, the GLAM layer 212 ingests the node features h∈ [symbol] ^{N×F} and the edge set ε, where N is the number of nodes and F is the number of features per node.

Node representations xᵢ are generated from the node features h (operation 248). Each node feature vector hᵢ is multiplied by the shared weight matrix W. As noted above, for each node i, the node features hᵢ are transformed into higher order representations xᵢ using a shared linear transformation W∈ [symbol] ^{F}^{_{S}}^{×F}:

xᵢ=W(\vec{h}ᵢ), xᵢ∈ [symbol] ^{F}^{_{S}} (8)

For each edge between nodes i and j in the provided edge set ε, a representation for that edge is constructed by concatenating the node representations xᵢ and xⱼ.

Structure learning scores, which are probabilities for retaining or discarding each edge, are generated (operation 252). Each edge is represented by the concatenation of the node representations i, j on either side of the edge (xᵢ∥xⱼ). As noted above, using another shared linear layer S∈ [symbol] ^{1×F}^{_{S}}, these edge representations are mapped onto structure learning scores η∈ [symbol] ^{|ε|×1}, where the ƒᵢⱼ score for each edge becomes:

ηᵢⱼ=σ(S[xᵢ∥xⱼ]+u) (9)

where ∥ is vector concatenation, u∈ [symbol] ¹ is i.i.d. noise drawn from a U(−0.5, 0.5) distribution centered about zero, and σ is a sigmoid activation allowing each ηᵢⱼ to be interpreted as the probability of retaining the edge between nodes i and j.

In one example embodiment, K attention heads are added (operation 256). Essentially, K independent S matrices (K independent linear layers) are generated, the outputs of the K attention heads are summed and the results are divided by K. As noted above, the GLAM layer 212 is optionally extended to include K attention heads, and the final structure learning score ηᵢⱼ for each edge becomes:

$${η}_{ij} = σ ( \frac{1}{K} {\sum }_{k = 1}^{K} {S}^{k} [ {x}_{i} ‖ {x}_{j} ] + u ) \qquad ( 10 )$$

A discrete mask ε′∈ε is sampled (operation 260). Essentially, a subset of edges ε′ is selected to identify a subgraph where the edges having a structure learning score ηᵢⱼ above a threshold, such as 0.5, are retained. As noted above, a discrete mask M∈{0, 1}^{|ε|} is sampled from the distribution parameterized by the structure learning scores η. When applied to the given graph ε, a sparsified graph M(ε)→ε′⊆ε′is obtained. To differentiably sample the discrete values in M from the continuous probabilities in η, the Gumbel-Softmax reparameterization technique is used and the edge between nodes i and j is retained if ηᵢⱼ is greater than a threshold, such as 0.5.

This new graph ε′ is then used in place of ε in the downstream GNN representation learner (operation 264) and an inferencing operation is performed using the downstream GNN representation learner based on the subgraph (operation 268). As noted above, if that downstream GNN were a GAT, using the equations from the section entitled Preliminaries, the attention coefficients would become:

$${α}_{ij} = {softmax}_{j} ( {e}_{ij} ) = \frac{exp ( {e}_{ij} )}{{\sum }_{j ∈ {𝒩}_{i}^{′}} exp ( {e}_{ij} )} \qquad ( 11 )$$

$$and$$

$${\vec{h}}_{i}^{′} = softmax ( \frac{1}{K} {\sum }_{k = 1}^{K} {\sum }_{j ∈ {𝒩}_{i}^{′}} {α}_{ij}^{k} {W}^{k} {\vec{h}}_{j} )$$

where the neighborhoods [symbol] are defined by the non-masked edges in ε′ where η is greater than a threshold.

It is worth noting that, in contrast to prior art approaches, one or more embodiments do not require edge-selection heuristics (such as top-k selection) or exogenous structural regularizers (such as penalties on retained edges) to stabilize the structure learning process, thus making one or more embodiments more readily deployable in existing GNN pipelines and obviating the need to interfere with carefully crafted objective functions or training methodologies.

### Experiments

In experiments with conventional techniques, citation datasets, and co-purchase datasets, it was demonstrated that one or more embodiments can match state of the art semi-supervised node classification accuracies while inducing an order of magnitude greater sparsity than existing graph learning methods.

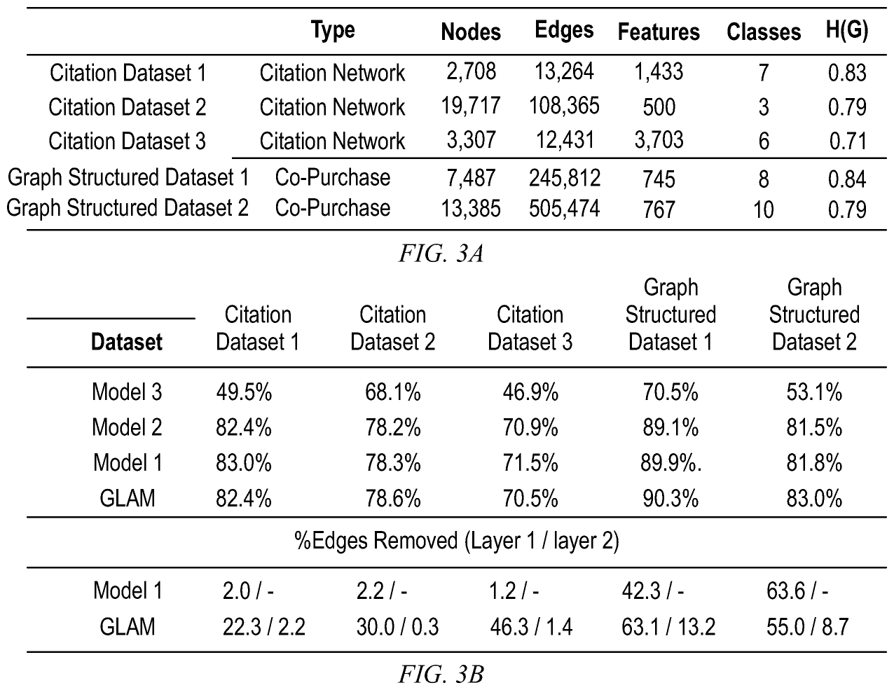

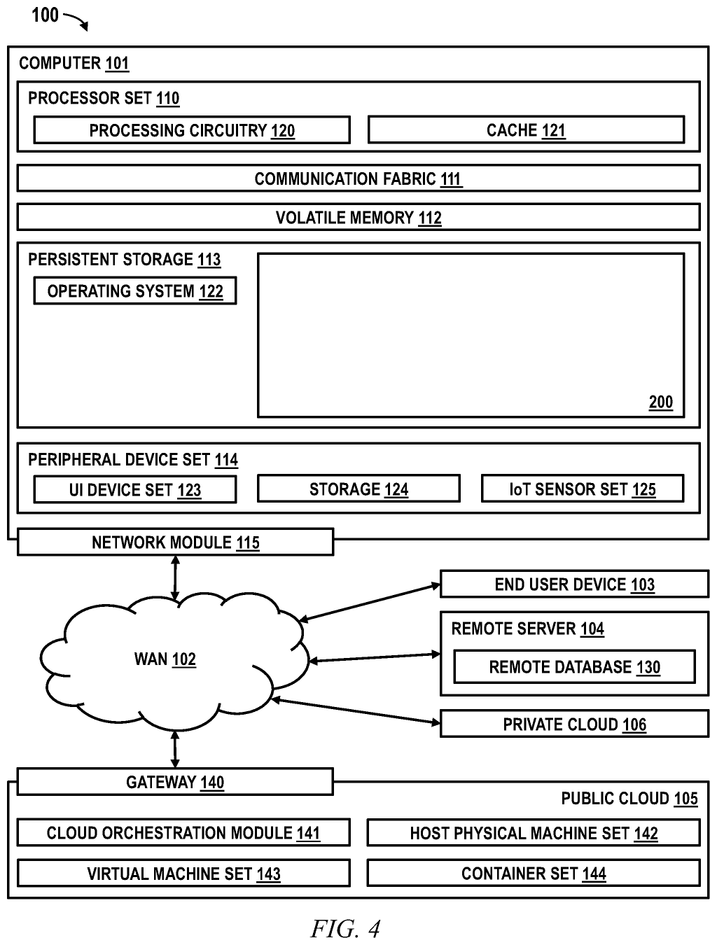

To demonstrate the efficacy of the GLAM layer 212, performance in semi-supervised node classification tasks on real-world graph datasets is discussed. As it is well known that the performance of GNNs is degraded by heterophilic graphs (in which adjacent nodes tend to have different labels), only those graphs where the edges bring material value for GNNs are considered, i.e. homophilous graphs, although graphs of all types are suitable. Formally, the edge homophily ratio of a graph is a value the range [0, 1] that denotes the fraction of edges in the graph that join nodes with the same labels:

$$H ( G , \{ {y}_{i} ; i ∈ 𝒱 \} ) = \frac{1}{\vert ε \vert} {\sum }_{( i , j ) ∈ ε} 𝕝 ( {y}_{i} = {y}_{j} ) \qquad ( 12 )$$

where G is an input graph with nodes v∈V having labels y. While homophily is not an unrealistic assumption, with most graphs being constructed this way, a method for graph-adaptation based on the assumptions of the downstream GNN is appropriate in one or more embodiments, since many GNN models implicitly assume a high degree of homophily and perform poorly when this assumption is violated. In graphs with low homophily, GNN performance is often optimized by removing nearly every edge. FIG. 3A is a table of evaluated homophilic graphs (datasets), in accordance with an example embodiment. For this reason, to get a better understanding of the GLAM layer's efficacy, the study was confined to the homophilic graphs detailed in the table of FIG. 3A.

Known Citation Datasets 1, 2, and 3 are citation datasets with relatively low average degree. Nodes correspond to documents (academic papers) and edges represent citations between these documents. Node features are the bag of words representation of the document and the task is to classify each document by its topic. Graph Structured Datasets 1 and 2 are co-purchase datasets with a much higher average degree, where each node corresponds to a product and two nodes are linked if those products are frequently bought together. The node features are also a bag of words representations but of the reviews of each product. Similarly, the task is to classify each product into its product category.

For a fair comparison with a similar conventional model (which also adapts the graph attention layer to learn sparse subgraphs, by attaching a binary gate to each edge in the given graph, then learning a single adjacency matrix that is shared across all layers—while effective, this adjacency matrix makes it difficult to scale and they employ an L₀ norm in the loss function to penalize retained edges), the same canonical splits were used in each dataset: 20 nodes per class for training, 500 nodes for validation and 1,000 for testing.

### Training Methodology

In all of our experiments, a two layer GAT was trained, using the GLAM layer 212 to learn optimal structures for each GAT layer. Crucially, to demonstrate how the GLAM layer 212 may be ‘dropped in’ to an existing GNN model with little to no modification to the training scheme, the known optimal hyperparameters and training methodology were used for the GAT layers without modification. This covered all components of the model including loss functions, regularization, optimizers, and layer sizes. The only hyperparameters modified were those associated with the inserted GLAM layers 212 and, as mentioned in the section entitled the Graph Learning Attention Mechanism (GLAM), the learned mask was enforced using a sparse softmax activation in the GAT layers that respects the mask M. As the co-purchase datasets were not tested in the original GAT paper, optimization began with the same hyperparameters as Citation Dataset 1, and it was found that increasing the hidden dimension from 8 to 32 led to optimal performance. In all cases, cross entropy was used as the loss function and a conventional optimizer was used to perform gradient descent (generally, any gradient descent based algorithm is suitable; the skilled artisan will be familiar with various suitable optimizers such as Adam, Adagrad, Adadelta, RMSprop, and the like). For the experiments, the average classification performance is reported herein and sparsity over 10 independent trials was induced (table of FIG. 3B).

Additionally, to make as few assumptions about the optimal graph as possible, the GLAM layer 212 was used to independently assess the utility of each edge at each layer, as shown in FIG. 1C, and the induced sparsity was reported at each layer. This is in contrast to existing methods which learn a single graph at the first layer that is then reused for all the downstream layers. As described in the section entitled Prediction Performance and Induced Sparsity, learning the optimal graph at each layer not only improves performance and induces greater sparsity but allows the relationship between the data, the GNN aggregator, and the downstream task to be observed more clearly.

FIG. 3B illustrates a table of semi-supervised node classification accuracies (top; listed in percent) and the percentage of edges removed at the first/second layer (bottom), in accordance with an example embodiment. The tables of FIG. 3B show the final results of the most comprehensive evaluation of the disclosed method on public datasets, relative to baseline and competitive models. For the similar conventional model, a single graph was learned at the first layer and reused for all the following layers. In the experiments, the GLAM layer 212 was used to learn an optimal graph at each layer.

It is noted here that the use of exogenous regularizers and edge-selection heuristics, as employed by conventional structure learning methods, is to help the structure learner better adapt to the demands of the downstream GNN. With the GLAM layer 212, this same sort of adaptation is enabled by simply making these layers more sensitive than the downstream GNN layers. To do so, the regularization (weight decay) is relaxed and the learning signal is amplified (increase the learning rate) for just the GLAM layers 212. Doing so for only the GLAM layers 212 allows them to adapt to the GNN representation learner without the need for additional terms in the loss function. These layer-wise changes are slight and optimal values vary by dataset.

Finally, as self-loops have disproportionate utility in any node-wise prediction task, the GLAM layers 212 only attend over those edges that adjoin separate nodes, retaining all self-loops by default.

### Prediction Performance and Induced Sparsity

On semi-supervised node classification datasets, the GLAM layer 212 enables the GAT to reach similar accuracies while inducing an order of magnitude greater sparsity than existing methods. This increased sparsification is notable, since sparsity constraints and penalizing retained edges were not explicitly enforced. Since the GLAM method addresses inducing task-informed subgraphs, and classification accuracies are all similar to the similar conventional model, the analysis is confined to the sparsification aspect of the results.

On each of the citation datasets, the GLAM layer 212 is competitive with the similar conventional model on prediction performance while inducing over an order of magnitude greater sparsity. Part of the advantage of the GLAM layer 212 is that it can be trained using only the signal from the downstream task. As such, the induced graph is purely a reflection of the relationship between the data, the GNN aggregation scheme, and the downstream task. Following from this, it is noted that the first GLAM layer 212 trained on these datasets removes closer to 1-H (G) percent of the edges. There is not an exact correspondence, but the proximity between these two quantities is likely a reflection of the GLAM layers 212 learning that the downstream GAT performs best on neighborhoods with higher homophily. The second GLAM layer 212 removes on the order of 1% of the edges, which is similar to the similar conventional model. It is hypothesized that more edges are retained in the second and final layer due to the node representations already containing information from their 1-hop neighborhood, and there being additional value in aggregating information from the 2-hop neighborhood.

On the co-purchase datasets which have much larger average degrees, the GLAM layers 212 remove substantially more edges in the first layer but fewer in the second. It is noted that, since there are no structural regularizers, GLAM 212 is not encouraged to learn the sparsest graph possible, but rather the graph which optimizes downstream task performance. As can be seen with the Graph Structured Dataset 2, retaining a few more edges in the first layer and a few less in the second resulted in substantially higher classification accuracies.

While one or more embodiments do not always achieve state of the art classification performance, similar performance is achieved with far greater sparsification and without changes to the canonical loss function.

### Time Series Forecasting

One or more embodiments lend themselves to a variety of practical applications. For example, consider environmental monitoring: a room comfort controller (implemented, for example, with a graph learning attention mechanism 200, described more fully below) collects time series data from a network of smart wireless Internet-of-Things (IoT) sensors of an IoT sensor set 125, such as temperature, humidity, light and voltage, the graph can be formed based on sensor location via k-Nearest Neighbor (KNN) or time series correlation. Based on the collected network of time series data and a trained model in the controller, the environmental comfort indicators are forecast for the next time horizon by the computer 101; based on the forecasting results, the controller will adjust the system, such as heating, air conditioning, humidifier or dehumidifier, lights, and the like, according to achieve the set comfort level.

In another aspect, consider smart transportation: a GPS routing advisor/automatic driving routing controller or the like (implemented with a graph learning attention mechanism 200, described more fully below) collects, via a WAN 102, time series data from a network of traffic sensor stations (e.g., thousand(s) of stations on the road network) associated with hourly average speed and occupancy; the graph can be the given road network or can be learned by temporal time series correlation. Based on the collected network of time series data and a trained model in the advisor/controller, the system, using the computer 101, forecasts the traffic in the next time horizon and advises of new routing.

One or more embodiments thus provide a principled framework for considering the graph structure learning problem in the context of graph neural networks, as well as the Graph Learning Attention Mechanism (GLAM), a novel structure learning layer. In contrast to existing structure learning approaches, in one or more embodiments, GLAM does not require exogenous structural regularizers nor does it utilize edge-selection heuristics. In experiments on citation and co-purchase datasets. the GLAM layer allows an unmodified GAT to match state of the art performance while inducing an order of magnitude greater sparsity than other graph learning approaches. Since one or more embodiments advantageously yield graph structures uncorrupted by the influence of exogenous heuristics, there is the potential for use in the design and analysis of novel GNN architectures. In the GLAM layer 212, edges are retained or discarded based whether the downstream GNN can make productive use of them. By interpreting the distributions of retained edges at each layer, designers can, for example, better understand how well some aggregation scheme integrates information from heterophilic vs. homophilic neighborhoods. In a similar way, GLAM 212 can be used as a principled method for assessing the value of depth in GNNs, a persistent issue due to the over-smoothing problem. If a GNN layer were to no longer benefit from the incorporation of structural information, i.e. the number of retained edges yielded by its preceding GLAM layer 212 was close to zero, then the GNN may be too deep, and adding additional layers may introduce complexity without increasing performance.

One or more embodiments provide discrete sampling and standard learnable graph attention. One or more embodiments add and/or remove edges from an existing graph. One or more embodiments do not employ a generator network or a de-noising autoencoder.

Given the discussion thus far, it will be appreciated that, in general terms, an exemplary method, according to an aspect of the invention, includes the operations of obtaining a graph with a plurality of nodes, a plurality of edges, and a plurality of node features (operation 244), generating node representations xᵢ for the node features (operation 248), generating a plurality of structure learning scores based on the node representations xᵢ, each structure learning score corresponding to one of the plurality of edges (operation 252), selecting a subset of the plurality of edges that identify a subgraph, each edge of the subset having a structure learning score that is greater than a given threshold (operation 260), inputting the subgraph to a representation learner (operation 264), and performing an inferencing operation using the representation learner based on the subgraph (operation 268).

In one example embodiment, the representation learner comprises a graph neural network.

In one example embodiment, the representation learner comprises a graph attention network (GAT) and wherein attention coefficients of the GAT are defined by:

$${α}_{ij} = {softmax}_{j} ( {e}_{ij} ) = \frac{exp ( {e}_{ij} )}{{\sum }_{j ∈ {𝒩}_{i}^{′}} exp ( {e}_{ij} )}$$

$$and$$

$${\vec{h}}_{i}^{′} = softmax ( \frac{1}{K} {\sum }_{k = 1}^{K} {\sum }_{j ∈ {𝒩}_{i}^{′}} {α}_{ij}^{k} {W}^{k} {\vec{h}}_{j} )$$

where neighborhoods [symbol] are defined by non-masked edges in the subset of the plurality of edges ε′, eᵢⱼ represents an edge of the plurality of edges between two nodes i,j of the plurality of nodes, W is a shared weight matrix, and where η>0.5.

In one example embodiment, the generating of the node representations xᵢ further comprises multiplying each node feature vector hᵢ by a shared linear transformation that is parameterized by a shared weight matrix W, where the node representations are designated by xᵢ and W∈ [symbol] ^{F}^{ₛ}^{×F}:

xᵢ=W(\vec{h}ᵢ), xᵢ∈ [symbol] ^{F}^{ₛ}

In one example embodiment, the structure learning scores comprise probabilities for retaining each edge of the plurality of edges, the node representations are designated by xᵢ and xⱼ, and wherein the generating of the structure learning scores further comprises:
generating an edge representation by concatenating node representations xᵢ and xⱼ for respective nodes on either side of the corresponding edge,
mapping the edge representations onto structure learning scores η∈ [symbol] ^{|ε|×1} using a shared linear layer S∈ [symbol] ^{1×F}^{ₛ},
adding noise u, and
   performing a sigmoid function to map a result of the mapping to a range between zero and one inclusive:

ηᵢⱼ=σ(S[xᵢ∥xⱼ]+u)

where ∥ is a vector concatenation, u∈ [symbol] ¹ is independent and identically distributed noise drawn from a U(−0.5, 0.5) distribution centered about zero, and σ is a sigmoid activation allowing each ηᵢⱼ to be interpreted as the probability of retaining a given edge of the plurality of edges that resides between nodes i and j.

In one example embodiment, the structure learning scores comprise probabilities for retaining each edge, the node representations are designated by xᵢ and xⱼ, and wherein the generating of the structure learning scores further comprises:
generating a representation of a given edge of the plurality of edges by concatenating node representations xᵢ and xⱼ for respective nodes on either side of the given edge,
   mapping the edge representation onto a structure learning score η∈ [symbol] ^{|ε|×1} using a shared linear layer S∈ [symbol] ^{1×F}^{ₛ}, and
   performing a sigmoid function to map a result of the mapping to a range between zero and one inclusive:

ηᵢⱼ=σ(S[xᵢ∥xⱼ])

where ∥ is a vector concatenation and σ is a sigmoid activation allowing each structure learning score ηᵢⱼ to be interpreted as the probability of retaining a corresponding edge of the plurality of edges that resides between a node i and a node j of the plurality of nodes.

In one example embodiment, K attention heads are added (operation 256).

In one example embodiment, the node representations are designated by xᵢ and xⱼ, and the adding K attention heads further comprises generating K independent S matrices, summing outputs of the K independent S matrices, and dividing the summed outputs by K to generate a final structure learning score nᵢⱼ for each edge:

$${η}_{ij} = σ ( \frac{1}{K} {\sum }_{k = 1}^{K} {S}^{k} S [ {x}_{i} ‖ {x}_{j} ] + u )$$

In one example embodiment, the method is performed without any exogenous regularizer and edge-selection heuristics.

In one example embodiment, an attempted online financial fraud event is identified based on a result of the inferencing operation and a completion of the attempted online financial fraud event is locked by changing a network security parameter. In one example embodiment, a node is classified as suspicious in regard to, for example, money laundering. In one example embodiment, a set of time series data is collected from a plurality of environmental sensors, one or more environmental comfort indicators are forecasted for a given time horizon based on the time series data and the subgraph, and a heating, ventilation and air conditioning system is controlled based on the forecasted environmental comfort indicators. In one example embodiment, a set of time series data is collected from a network of traffic sensor stations, traffic for a given time horizon is forecasted based on the time series data and the subgraph, and an autonomous vehicle is controlled based on the forecast traffic.

In one example embodiment, the inputting the subgraph to the representation learner (operation 264) further comprises incorporating the subgraph into a Graph Convolutional Network (GCN) by multiplying an adjacency matrix A by a mask M before an application of a renormalization trick.

In one aspect, a non-transitory computer readable medium comprises computer executable instructions which when executed by a computer cause the computer to perform the method of obtaining a graph with a plurality of nodes, a plurality of edges, and a plurality of node features (operation 244), generating node representations xᵢ for the node features (operation 248), generating a plurality of structure learning scores based on the node representations xᵢ, each structure learning score corresponding to one of the plurality of edges (operation 252), selecting a subset of the plurality of edges that identify a subgraph, each edge of the subset having a structure learning score that is greater than a given threshold (operation 260), inputting the subgraph to a representation learner (operation 264), and performing an inferencing operation using the representation learner based on the subgraph (operation 268).

In one aspect, an apparatus comprises a memory and at least one processor, coupled to the memory, and operative to perform operations comprising obtaining a graph with a plurality of nodes, a plurality of edges, and a plurality of node features (operation 244), generating node representations xᵢ for the node features (operation 248), generating a plurality of structure learning scores based on the node representations xi, each structure learning score corresponding to one of the plurality of edges (operation 252), selecting a subset of the plurality of edges that identify a subgraph, each edge of the subset having a structure learning score that is greater than a given threshold (operation 260), inputting the subgraph to a representation learner (operation 264), and performing an inferencing operation using the representation learner based on the subgraph (operation 268).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as graph learning attention mechanism 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
obtaining a graph with a plurality of nodes, a plurality of edges, and a plurality of node features;
generating node representations for the node features;
generating a plurality of structure learning scores based on the node representations, each structure learning score corresponding to one of the plurality of edges;
selecting a subset of the plurality of edges that identify a subgraph, each edge of the subset having a structure learning score that is greater than a given threshold;
inputting the subgraph to a representation learner; and
performing an inferencing operation using the representation learner based on the subgraph.

2. The method of claim 1, wherein the representation learner comprises a graph neural network.

3. The method of claim 1, wherein the representation learner comprises a graph attention network (GAT) and wherein attention coefficients of the GAT are defined by:
$${α}_{ij} = {softmax}_{j} ( {e}_{ij} ) = \frac{exp ( {e}_{ij} )}{{\sum }_{j ∈ {𝒩}_{i}^{′}} exp ( {e}_{ij} )}$$
$$and$$
$${\vec{h}}_{i}^{′} = softmax ( \frac{1}{K} {\sum }_{k = 1}^{K} {\sum }_{j ∈ {𝒩}_{i}^{′}} {α}_{ij}^{k} {W}^{k} {\vec{h}}_{j} )$$
where neighborhoods [symbol] are defined by non-masked edges in the subset of the plurality of edges ε′, eᵢⱼ represents an edge of the plurality of edges between two nodes i,j of the plurality of nodes, W is a shared weight matrix, and where η>0.5.

4. The method of claim 1, wherein the generating of the node representations xᵢ further comprises multiplying each node feature vector hᵢ by a shared linear transformation that is parameterized by a shared weight matrix W, where the node representations are designated by xᵢ and W∈ [symbol] ^{F}^{ₛ}^{×F}:
xᵢ=W(\vec{h}ᵢ), xᵢ∈ [symbol] ^{F}^{ₛ}

5. The method of claim 1, wherein the structure learning scores comprise probabilities for retaining each edge of the plurality of edges, the node representations are designated by xᵢ and xⱼ, and wherein the generating of the structure learning scores further comprises:
generating an edge representation by concatenating node representations xᵢ and xⱼ for respective nodes on either side of the corresponding edge,
mapping the edge representations onto structure learning scores η∈ [symbol] ^{|ε|×1} using a shared linear layer S∈ [symbol] ^{1×F}^{ₛ},
adding noise u, and
performing a sigmoid function to map a result of the mapping to a range between zero and one inclusive:
ηᵢⱼ=σ(S[xᵢ∥xⱼ]+u)
where ∥ is a vector concatenation, u∈ [symbol] ¹ is independent and identically distributed noise drawn from a U(−0.5, 0.5) distribution centered about zero, and σ is a sigmoid activation allowing each ηᵢⱼ to be interpreted as the probability of retaining a given edge of the plurality of edges that resides between nodes i and j.

6. The method of claim 1, wherein the structure learning scores comprise probabilities for retaining each edge, the node representations are designated by xᵢ and xⱼ, and wherein the generating of the structure learning scores further comprises:
generating a representation of a given edge of the plurality of edges by concatenating node representations xᵢ and xⱼ for respective nodes on either side of the given edge,
mapping the edge representation onto a structure learning score η∈ [symbol] ^{|ε|×1} using a shared linear layer S∈ [symbol] ^{1×F}^{ₛ}, and
performing a sigmoid function to map a result of the mapping to a range between zero and one inclusive:
ηᵢⱼ=σ(S[xᵢ∥xⱼ])
where ∥ is a vector concatenation and σ is a sigmoid activation allowing each structure learning score ηᵢⱼ to be interpreted as the probability of retaining a corresponding edge of the plurality of edges that resides between a node i and a node j of the plurality of nodes.

7. The method of claim 1, further comprising adding K attention heads, wherein the node representations are designated by xᵢ and xⱼ, and the adding K attention heads further comprises generating K independent S matrices, summing outputs of the K independent S matrices, and dividing the summed outputs by K to generate a final structure learning score ηᵢⱼ for each edge:
$${η}_{ij} = σ ( \frac{1}{K} {\sum }_{k = 1}^{K} {S}^{k} S [ {x}_{i} ‖ {x}_{j} ] + u )$$

8. The method of claim 1, wherein the method is performed without any exogenous regularizer and edge-selection heuristics.

9. The method of claim 1, further comprising:
identifying an attempted online financial fraud event based on a result of the inferencing operation; and
blocking a completion of the attempted online financial fraud event by changing a network security parameter.

10. The method of claim 1, further comprising:
collecting a set of time series data from a plurality of environmental sensors;
forecasting one or more environmental comfort indicators for a given time horizon based on the time series data and the subgraph; and
controlling a heating, ventilation and air conditioning system based on the forecasted environmental comfort indicators.

11. The method of claim 1, further comprising:
collecting a set of time series data from a network of traffic sensor stations;
forecasting traffic for a given time horizon based on the time series data and the subgraph; and
controlling an autonomous vehicle based on the forecast traffic.

12. The method of claim 1, wherein the inputting the subgraph to the representation learner further comprises incorporating the subgraph into a Graph Convolutional Network (GCN) by multiplying an adjacency matrix A by a mask M before an application of a renormalization trick.

13. A non-transitory computer readable medium comprising computer executable instructions which when executed by a computer cause the computer to perform the method of:
obtaining a graph with a plurality of nodes, a plurality of edges, and a plurality of node features;
generating node representations for the node features;
generating a plurality of structure learning scores based on the node representations xᵢ, each structure learning score corresponding to one of the plurality of edges;
selecting a subset of the plurality of edges that identify a subgraph, each edge of the subset having a structure learning score that is greater than a given threshold;
inputting the subgraph to a representation learner; and
performing an inferencing operation using the representation learner based on the subgraph.

14. The non-transitory computer readable medium of claim 13, wherein the representation learner comprises a graph neural network.

15. An apparatus comprising:
a memory; and
at least one processor, coupled to said memory, and operative to perform operations comprising:
obtaining a graph with a plurality of nodes, a plurality of edges, and a plurality of node features;
generating node representations for the node features;
generating a plurality of structure learning scores based on the node representations xᵢ, each structure learning score corresponding to one of the plurality of edges;
selecting a subset of the plurality of edges that identify a subgraph, each edge of the subset having a structure learning score that is greater than a given threshold;
inputting the subgraph to a representation learner; and
performing an inferencing operation using the representation learner based on the subgraph.

16. The apparatus of claim 15, wherein the representation learner comprises a graph attention network (GAT) and wherein attention coefficients of the GAT are defined by:
$${α}_{ij} = {softmax}_{j} ( {e}_{ij} ) = \frac{exp ( {e}_{ij} )}{{\sum }_{j ∈ {𝒩}_{i}^{′}} exp ( {e}_{ij} )}$$
$$and$$
$${\vec{h}}_{i}^{′} = softmax ( \frac{1}{K} {\sum }_{k = 1}^{K} {\sum }_{j ∈ {𝒩}_{i}^{′}} {α}_{ij}^{k} {W}^{k} {\vec{h}}_{j} )$$
where neighborhoods [symbol] ᵢ′ are defined by non-masked edges in the subset of the plurality of edges ε′, eᵢⱼ represents an edge of the plurality of edges between two nodes i,j of the plurality of nodes, W is a shared weight matrix, and where η>0.5.

17. The apparatus of claim 15, wherein the generating of the node representations xᵢ further comprises multiplying each node feature vector hᵢ by a shared linear transformation that is parameterized by a shared weight matrix W, the node representations are designated by xᵢ, and W∈ [symbol] ^{F}^{ₛ}^{×F}:
xᵢ=W(\vec{h}ᵢ), xᵢ∈ [symbol] ^{F}^{ₛ}

18. The apparatus of claim 15, wherein the structure learning scores comprise probabilities for retaining each edge of the plurality of edges, the node representations are designated by xᵢ and xⱼ, and wherein the generating of the structure learning scores further comprises:
generating an edge representation by concatenating node representations xᵢ and xⱼ for respective nodes on either side of the corresponding edge,
mapping the edge representations onto structure learning scores η∈ [symbol] ^{|ε|×1} using a shared linear layer S∈ [symbol] ^{1×F}^{ₛ},
adding noise u, and
performing a sigmoid function to map a result of the mapping to a range between zero and one inclusive:
ηᵢⱼσ(S[xᵢ∥xⱼ]+u)
where ∥ is a vector concatenation, u∈ [symbol] is independent and identically distributed noise drawn from a U(−0.5, 0.5) distribution centered about zero, and σ is a sigmoid activation allowing each ηᵢⱼ to be interpreted as the probability of retaining a given edge of the plurality of edges that resides between nodes i and j.

19. The apparatus of claim 15, wherein the structure learning scores comprise probabilities for retaining each edge, the node representations are designated by xᵢ and xⱼ, and wherein the generating of the structure learning scores further comprises:
generating a representation of a given edge of the plurality of edges by concatenating node representations xᵢ and xⱼ for respective nodes on either side of the given edge,
mapping the edge representation onto a structure learning score η∈ [symbol] ^{|ε|×1} using a shared linear layer S∈ [symbol] ^{1×F}^{ₛ}, and
performing a sigmoid function to map a result of the mapping to a range between zero and one inclusive:
ηᵢⱼ=σ(S[xᵢ∥xⱼ])
where ∥ is a vector concatenation and σ is a sigmoid activation allowing each structure learning score nᵢⱼ to be interpreted as the probability of retaining a corresponding edge of the plurality of edges that resides between a node i and a node j of the plurality of nodes.

20. The apparatus of claim 15, the operations further comprising adding K attention heads, wherein the node representations are designated by xᵢ and xⱼ and the adding K attention heads further comprises generating K independent S matrices, summing outputs of the K independent S matrices, and dividing the summed outputs by K to generate a final structure learning score ηᵢⱼ for each edge:
$${η}_{ij} = σ ( \frac{1}{K} {\sum }_{k = 1}^{K} {S}^{k} S [ {x}_{i} ‖ {x}_{j} ] + u ) .$$
